(19) United States
(12) Patent Application Publication
(10) Pub. No.: US 2026/0052406 A1
(43) Pub. Date: Feb. 19, 2026

(54) EFFICIENT COLLECTION OF DISTRIBUTED DATA IN RAN

(71) Applicant: Telefonaktiebolaget LM Ericsson (publ), Stockholm (SE)

(72) Inventors: Philipp BRUHN, Aachen (DE); Germán BASSI, Årsta (SE); Angelo CENTONZA, Granada (ES); Luca LUNARDI, Genova (IT); Panagiotis SALTSIDIS, Stockholm (SE); Ioanna PAPPA, Stockholm (SE); Pablo SOLDATI, Solna (SE)

(73) Assignee: Telefonaktiebolaget LM Ericsson (publ), Stockholm (SE)

(21) Appl. No.: 19/101,032

(22) PCT Filed: Aug. 2, 2023
(86) PCT No.: PCT/EP2023/071361

§ 371 Date: Feb. 4, 2025

(30) Foreign Application Priority Data
Aug. 5, 2022 (GR) 20220100645

(51) Int. Cl. H04W 24/08; H04L 41/16; H04W 24/02

(52) U.S. Cl. CPC H04W 24/08; H04L 41/16; H04W 24/02

(57) ABSTRACT

In one aspect, a computer-implemented method performed by a first network node in a radio access network (RAN) is provided. The method includes obtaining an output from a machine learning (ML) model. The method includes obtaining an output feedback identifier for the output, wherein the output feedback identifier uniquely identifies the output. The method includes generating a first message, wherein the first message comprises the output feedback identifier. The method includes transmitting, towards a third network node, the first message comprising the output feedback identifier.

### TECHNICAL FIELD

Disclosed are embodiments related to multi-agent reinforcement learning (“RL”), distributed optimization, self-organizing networks (“SONs”), zero-touch automation, and mobility simulation for optimizing radio access networks.

### INTRODUCTION

3GPP TR 37.817 (v17.0.0): “Study on Enhancement for Data Collection for NR and EN-DC” (Release 17) (“TR 37.817”) provides descriptions of principles for RAN intelligence enabled by AI. FIG. 1 illustrates a functional framework for RAN intelligence. FIG. 1 outlines AI functionality as well as inputs and outputs for AI enabled optimization, as well as use cases and solutions of AI enabled RAN. The study is based on the current architecture and interfaces, and the analyzed use cases include Network Energy Saving, Load Balancing, and Mobility Optimization.

For each use case, AI/ML Model Training is located either in the OAM or in the gNB, specifically in the gNB-CU. FIGS. 2-4 each depict Model Training located in the OAM for the three uses cases, including Network Energy Saving, Load Balancing, and Mobility Optimization.

TR 37.817 mentions the use of “Feedback.” Section 4.2 of TR 37.817 states: “Actor is a function that receives the output from the Model Inference function and triggers or performs corresponding actions. The Actor may trigger actions directed to other entities or to itself. Feedback: Information that may be needed to derive training data, inference data or to monitor the performance of the AI/ML Model and its impact to the network through updating of KPIs and performance counters.”

As described below, NG-RAN node 1 hosts the Model Inference, and NG-RAN node 2, which is any neighboring NG-RAN node of NG-RAN node 1, both provide feedback to the OAM related to the Network Energy Saving, Load Balancing, or Mobility Optimization action taken by NG-RAN node. Section 5.1.2.6, Section 5.2.2.6, and Section 5.3.2.6 in TR 37.817 list the type of feedback given for AI/ML-based Network Energy Saving, Load Balancing, and Mobility Optimization use case. In one example, the action taken by NG-RAN node 1 (serving NG-RAN node) entails a handover of at least one UE to NG-RAN node 2 (target NG-RAN node). In this example, the feedback (in this case provided to the OAM) includes UE performance (e.g., of handed-over UEs) affected by the action, including QoS parameters such throughput/bitrate, packet delay/latency, packet loss, etc. Additional details can be found in TR 37.817.

FIG. 2 illustrates signaling among a UE (208), NG-RAN node 1 (202), a NG-RAN node 2 (204), and an OAM (206). Section 5.1.2.2 of TR 37.817 for the Network Energy Saving use case provides that the NG-RAN node 1 (202) makes energy decisions using AI/ML model trained from OAM (206).
Step 0: NG-RAN node 2 is assumed to have an AI/ML model optionally, which can provide NG-RAN node 1 with input information.
Step 1: NG-RAN node 1 configures the measurement information on the UE side and sends configuration message to UE to perform measurement procedure and reporting.
Step 2: The UE collects the indicated measurement(s), e.g., UE measurements related to RSRP, RSRQ, SINR of serving cell and neighbouring cells.
Step 3: The UE sends the measurement report message(s) to NG-RAN node 1.
Step 4: NG-RAN node 1 further sends UE measurement reports together with other input data for Model Training to OAM.
Step 5: NG-RAN node 2 (assumed to have an AI/ML model optionally) also sends input data for Model Training to OAM.
Step 6: Model Training at OAM. Required measurements and input data from other NG-RAN nodes are leveraged to train AI/ML models for network energy saving.
Step 7: OAM deploys/updates AI/ML model into the NG-RAN node(s). The NG-RAN node can also continue model training based on the received AI/ML model from OAM. Note: This step is out of RAN3 Rel-17 scope.
Step 8: NG-RAN node 2 sends the required input data to NG-RAN node 1 for model inference of AI/ML-based network energy saving.
Step 9: UE sends the UE measurement report(s) to NG-RAN node 1.
Step 10: Based on local inputs of NG-RAN node 1 and received inputs from NG-RAN node 2, NG-RAN node 1 generates model inference output(s) (e.g., energy saving strategy, handover strategy, etc.).
Step 11: NG-RAN node 1 sends Model Performance Feedback to OAM if applicable. Note: This step is out of RAN3 scope.
Step 12: NG-RAN node 1 executes Network energy saving actions according to the model inference output. NG-RAN node 1 may select the most appropriate target cell for each UE before it performs handover, if the output is handover strategy.
Step 13: NG-RAN node 2 provides feedback to OAM.
Step 14: NG-RAN node 1 provides feedback to OAM.

Section 5.1.2.6 of TR 37.817 for the Network Energy Saving use case states:

### Feedback of AI/ML-Based Network Energy Saving

To optimize the performance of an AI/ML-based network energy saving model, the following feedback can be considered to be collected from NG-RAN nodes: (i) Resource status of neighboring NG-RAN node(s); (ii) Energy efficiency; (iii) UE performance affected by the energy saving action (e.g., handed-over UEs), including bitrate, packet loss and latency; and/or (iv) System KPIs (e.g., throughput, delay, RLF of current and neighboring NG-RAN node(s)).

FIG. 3 illustrates signaling among a UE (308), NG-RAN node 1 (302), NG-RAN node 2 (304), and OAM (306). Section 5.2.2.2 of TR 37.817 describes a high-level signaling flow for the AI/ML use case related to Load Balancing with Model Training in OAM (306) and Model Inference in NG-RAN node 1 (302).
Step 0: NG-RAN node 2 is assumed to have an AI/ML model optionally, which can provide NG-RAN node 1 with useful input information, such as predicted resource status, etc.
Step 1: The NG-RAN node 1 configures the UE to provide measurements and/or location information (e.g., RRM measurements, MDT measurements, velocity, position).
Step 2: The UE collects the indicated measurement(s), e.g., UE measurements related to RSRP, RSRQ, SINR of serving cell and neighbouring cells.
Step 3: The UE reports to NG-RAN node 1 requested measurements and/or location information (e.g., UE measurements related to RSRP, RSRQ, SINR of serving cell and neighbouring cells, velocity, position).
Step 4: NG-RAN node 1 further sends UE measurement reports together with other input data for Model Training to OAM. NG-RAN node 2 also sends input data for Model Training to OAM.
Step 5: AI/ML Model Training is located at OAM. The required measurements and input data from other NG-RAN nodes are leveraged to train the AI/ML model.
Step 6: OAM deploys/updates AI/ML model into the NG-RAN node(s). The NG-RAN node is allowed to continue model training based on the received AI/ML model from OAM. Note: This step is out of RAN3 Rel-17 scope.
Step 7: The UE collects and reports to NG-RAN node 1 requested measurements or location information.
Step 8: The NG-RAN node 1 receives from the neighbouring NG-RAN node 2 the input information for load balancing model inference.
Step 9: NG-RAN node 1 performs model inference and generate Load Balancing predictions or decisions.
Step 10. The NG-RAN 1 sends the model performance feedback to OAM if applicable. Note: This step is out of RAN3 scope.
Step 11: NG-RAN node 1 may take Load Balancing actions and the UE is moved from NG-RAN node 1 to NG-RAN node 2.
Step 12: NG-RAN node 1 and NG-RAN node 2 send feedback information to OAM.

Section 5.2.2.6 of TR 37.817 for the Load Balancing use case further describes Feedback of AI/ML-based Load Balancing and states as follows: To optimize the performance of an AI/ML-based load balancing model, the following feedback can be considered to be collected from NG-RAN nodes: (i) UE performance information from target NG-RAN node (for those UEs handed over from source NG-RAN node); (ii) Resource status information updates from target NG-RAN node; and/or (iii) System KPIs (e.g., throughput, delay, RLF of current and neighboring NG-RAN node(s)).

FIG. 4 illustrates signaling among a UE (408), NG-RAN node 1 (402), NG-RAN node 2 (404), and OAM (406). Section 5.3.2.2 of TR 37.817 for the Mobility Optimization use case provides:
Step 0. NG-RAN node 2 is assumed to optionally have an AI/ML model, which can generate required input such as resource status and utilization prediction/estimation etc.
Step 1. The NG-RAN node configures the measurement information on the UE side and sends configuration message to UE including configuration information.
Step 2. The UE collects the indicated measurement, e.g., UE measurements related to RSRP, RSRQ, SINR of serving cell and neighbouring cells.
Step 3. The UE sends measurement report message to NG-RAN node 1 including the required measurement.
Step 4. The NG-RAN node 1 sends the input data for training to OAM, where the input data for training includes the required input information from the NG-RAN node 1 and the measurement from UE.
Step 5. The NG-RAN node 2 sends the input data for training to OAM, where the input data for training includes the required input information from the NG-RAN node 2. If the NG-RAN node 2 executes the AI/ML model, the input data for training can include the corresponding inference result from the NG-RAN node 2.
Step 6. Model Training. Required measurements are leveraged to training AI/ML model for UE mobility optimization.
Step 7. OAM sends AI/ML Model Deployment Message to deploy the trained/updated AI/ML model into the NG-RAN node(s). The NG-RAN node can also continue model training based on the received AI/ML model from OAM. Note: This step is out of RAN3 Rel-17 scope.
Step 8. The NG-RAN node 1 obtains the measurement report as inference data for UE mobility optimization.
Step 9. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.
Step 10. Model Inference. Required measurements are leveraged into Model Inference to output the prediction, e.g., UE trajectory prediction, target cell prediction, target NG-RAN node prediction, etc.
Step 11. The NG-RAN 1 sends the model performance feedback to OAM if applicable. Note: This step is out of RAN3 scope.
Step 12: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.
Step 13. The NG-RAN node 1 sends the feedback information to OAM.
Step 14. The NG-RAN node 2 sends the feedback information to OAM.

Section 5.3.2.6 of TR 37.817 for the Mobility Optimization use case further describes Feedback as follows: To optimize the performance of an AI/ML-based mobility optimization model, the following data is required as feedback data: (i) QoS parameters such as throughput, packet delay, etc. of handed-over UE; (ii) Resource status information updates from target NG-RAN node; and/or (iii) Performance information from target NG-RAN node (the details of the performance information are to be discussed during normative work phase).

TR 37.817 also studies the case where both the AI/ML Model Training and the AI/ML Model Inference are located at NG-RAN (i.e., gNB). In this case, the feedback is signaled from NG-RAN node 2 to the NG-RAN node 1 hosting the Model Training and Model Inference function but is the same as described above.

TR 37.817 also mentions the use of so-called “Model Performance Feedback.” Section 4.2 of TR 37.817 states:
Model Inference is a function that provides AI/ML model inference output (e.g. predictions or decisions). Model Inference function may provide Model Performance Feedback to Model Training function when applicable. The Model Inference function is also responsible for data preparation (e.g. data pre-processing and cleaning, formatting, and transformation) based on Inference Data delivered by a Data Collection function, if required.
Output: The inference output of the AI/ML model produced by a Model Inference function. (Note: Details of inference output are use case specific.)
Model Performance Feedback: It may be used for monitoring the performance of the AI/ML model, when available. (Note: Details of the Model Performance Feedback process are out of RAN3 scope.)

### SUMMARY

As can be seen from TR 37.817, the Feedback is intended to provide an indication on the performance of the AI/ML model, but it has not been defined yet. One problem with the current technology is that a node receiving feedback (information), e.g., the OAM, receives feedback related to the same AI/ML model inference output, e.g., an action, from two or more nodes, e.g., NG-RAN nodes. This means that the node receiving the feedback, or more precisely, e.g., the Model Training function hosted therein, which is responsible for preparing training data, must identify and connect/combine all feedback received from multiple nodes related to the same output, e.g., AI/ML-based action. In practice, associating information including feedback received from several nodes to a specific output, e.g., action triggered or taken by a specific node at a specific time, is a difficult task because each node may be running multiple use cases in parallel, and each node may be reporting information related to outputs e.g., actions, taken by itself as well as actions taken by other (e.g., neighboring) nodes for the different use cases to the node hosting the Model Training function and/or Model Inference function.

The problem can be further explained with two examples. In one example, two NG-RAN nodes, here called NG-RAN nodes 1A and 1B, host a Model Inference function and perform Mobility Optimization for their respective (served) sets of UEs using AI/ML models. Both NG-RAN nodes decide to handover one of their UEs each to a common third NG-RAN node, here called NG-RAN node 2, at the same time or at close time instances. NG-RAN node 2 will then observe the performance of the two handed-over UEs for some time and report it to the OAM, but the OAM does not know which UE has been handed over as per which of the Mobility Optimization actions taken respectively by NG-RAN nodes 1A and 1B, so it does not know which UE performance feedback received from NG-RAN node 2 corresponds to which of the two actions.

In another example, one NG-RAN node, here called NG-RAN node 1, performs AI/ML model inference for Network Energy Saving and Mobility Optimization in parallel. At a certain point, using its Mobility Optimization model, NG-RAN node 1 decides to handover a UE to another NG-RAN node, again called NG-RAN node 2. Thereupon, using its Network Energy Saving model, NG-RAN node 1 decides to also handover the remaining UEs to NG-RAN node 2 (e.g., because the traffic/load in cells of NG-RAN node 2 is now below a certain threshold); NG-RAN node 2 will then observe the UE performance of the two sets of handed-over UEs and report it to the OAM. But again, the OAM does not know which set of UEs has been handed over due to which action, so it does not know which UE performance feedback received from NG-RAN node 2 corresponds to which action.

Another problem with the current specifications is that the model performance feedback metrics and other feedback metrics are not specified yet. It has been agreed that an AI/ML model is implementation specific and will therefore not be specified. For that reason, metrics or other indicators that express model performance feedback cannot be dependent on the specific model implementation. As an example, expressing model performance feedback as the processing power required by an AI/ML model to run would not be a correct metric, because the required processing power strictly depends on the implementation nature of the model, e.g., its complexity, output/action scope, etc. It thus cannot be considered as absolute indicator of how well the model is performing. The problem is therefore defining metrics that express the AL/ML model performance in a way that is AI/ML model implementation agnostic.

Aspects of the present disclosure include a method that enables a first or a second network node, (e.g., RAN nodes, such as NG-RAN nodes, gNB-CUs and/or gNB-DUs, or UEs) to provide to a third network node (e.g., another a RAN node or an external system, such as an OAM or SMO system) information associated to the execution of an AI/ML model (by the first or the second network node). The method enables the third node to efficiently collect data associated to the execution of an AI/ML model from multiple network nodes affected by the model execution in order to monitor/evaluate the model performance or generate new training data. The collected information associated to the execution of an AI/ML model may include information related to the output of the AI/ML model, performance feedback, etc.

In some embodiments, an output of an AI/ML model may represent an action associated with a RAN functionality, such as a UE handover, predicted by the AI/ML model and applied/taken by a first node or the second node. In other examples, the output of the AI/ML model may represent information associated with one or more actions that can be taken by the first or second node, such as an action value, so that an action may be selected based on the output of the AI/ML model. In yet other cases, the output of the AI/ML model may represent one or more predictions of a measurable quantity, or a metric, which could be used by a first node and/or signaled to a second as such. In either case, data (such as feedback information) from one or more RAN nodes is needed, e.g., by the third node, for the purposes stated above.

According to some embodiments, the feedback (information) associated with an AI/ML model or with an output thereof is reported by the first node, e.g., NG-RAN node, and/or one or more second nodes, e.g., NG-RAN nodes or UEs, to a third network node. The method enables the third node to receive from many (e.g., first and second) nodes information including feedback related to many outputs generated at different (first) nodes at different times, potentially time delayed and upon request, and still distinguish to which specific output each feedback is related to. The latter enables the third node to assess the performance impact of every AI/ML output generated by the various nodes in the system, e.g., the performance impact of the AI/ML-based or AI/ML-triggered action chosen and applied by the different nodes, and to determine the performance of the deployed AI/ML models.

According to one aspect, a computer-implemented method performed by a first network node in a radio access network (RAN) is provided. The method includes obtaining an output from a machine learning (ML) model. The method includes obtaining an output feedback identifier for the output, wherein the output feedback identifier uniquely identifies the output. The method includes generating a first message, wherein the first message comprises the output feedback identifier. The method includes transmitting, towards a third network node, the first message comprising the output feedback identifier.

According to another aspect, a computer-implemented method performed by a second network node is provided. The method includes receiving a first message generated by a first network node, the first message comprising an output from a machine learning (ML) model. The method includes obtaining an output feedback identifier related to the output. The method includes collecting data relating to the output or the execution of the output. The method includes generating a second message, the second message comprising the collected data and the output feedback identifier. The method includes transmitting the second message towards the first network node or a third network node.

According to yet another aspect, a computer-implemented method performed by a third network node is provided. The method includes receiving, from a first network node or a second network node, an output feedback identifier related to an output from a machine learning (ML) model. The method includes receiving, from the first network node or the second network node, data relating to the output. The method includes associating, using the output feedback identifier, the data with the output from the ML model.

In another aspect there is provided a network node with processing circuitry adapted to perform the methods described above. In another aspect there is provided a computer program comprising instructions which when executed by processing circuitry of a network node causes the network node to perform the methods described above. In another aspect there is provided a carrier containing the computer program, where the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a functional framework for RAN intelligence.

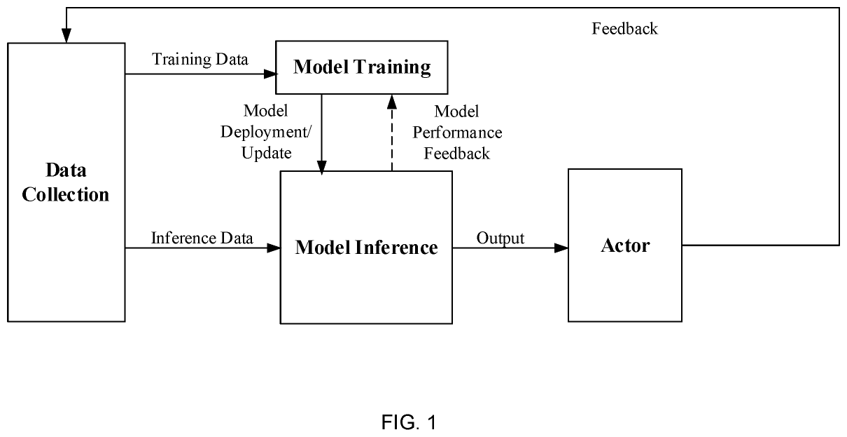

FIG. 2 illustrates AI/ML Model Training at OAM and Model Inference at NG-RAN for a first use case.

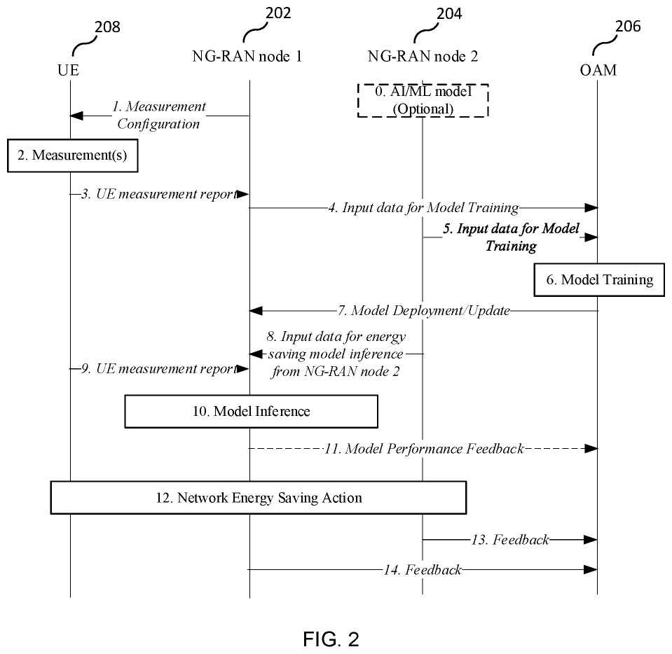

FIG. 3 illustrates AI/ML Model Training at OAM and Model Inference at NG-RAN for a second use case.

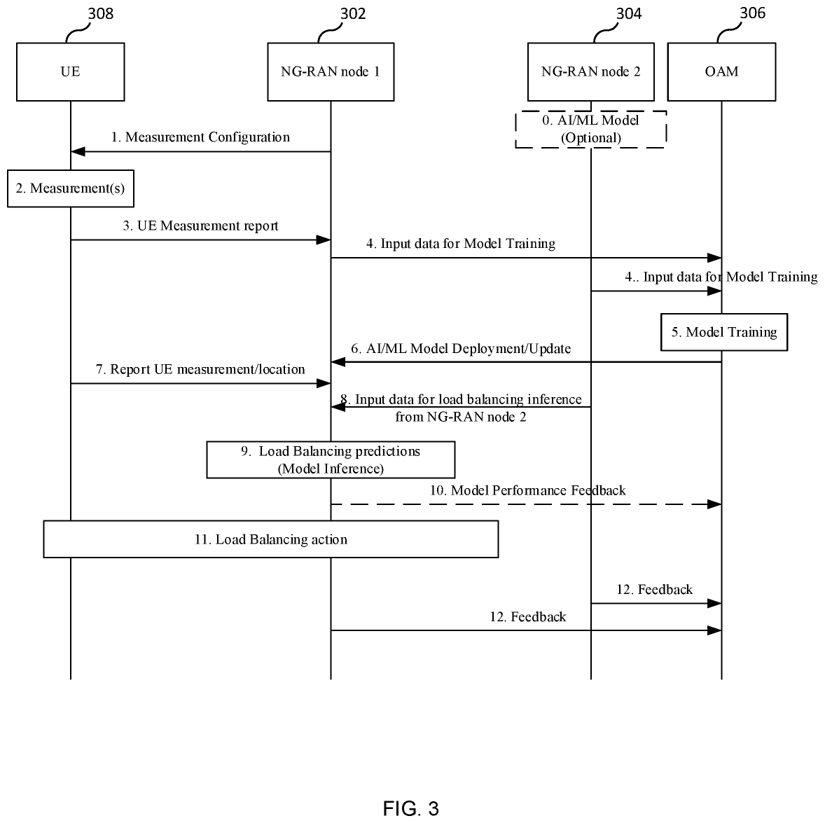

FIG. 4 illustrates AI/ML Model Training at OAM and Model Inference at NG-RAN for a third use case.

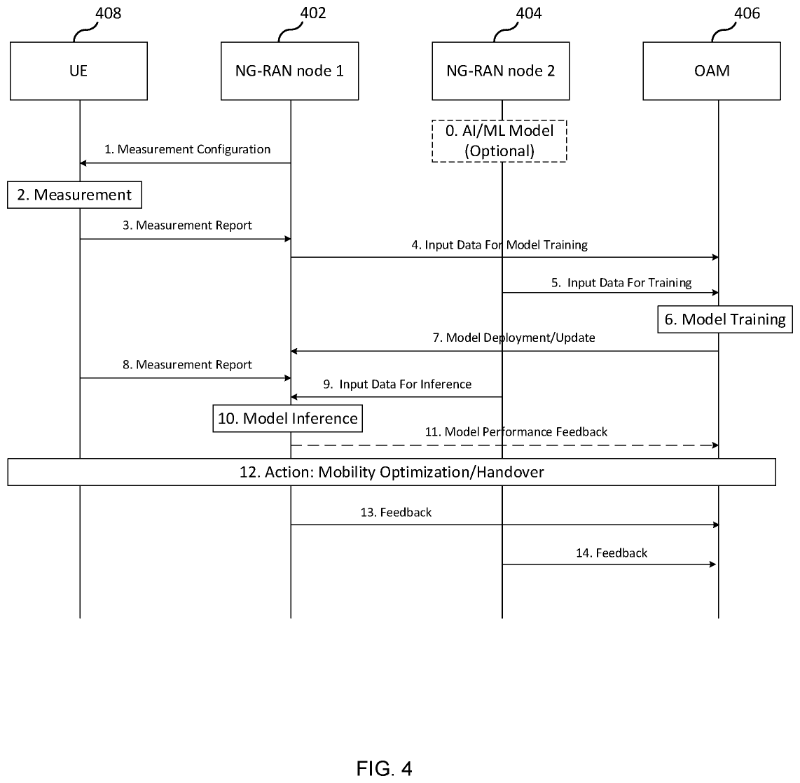

FIG. 5 illustrates a simplified flow chart, according to some embodiments.

FIG. 6 illustrates a flow chart, according to some embodiments.

FIG. 7 illustrates a flow chart, according to some embodiments.

FIG. 8 illustrates a flow chart, according to some embodiments.

FIG. 9 illustrates a method, according to some embodiments.

FIG. 10 illustrates a method, according to some embodiments.

FIG. 11 illustrates a method, according to some embodiments.

FIG. 12 a block diagram of a network node, according to some embodiments.

FIG. 13 illustrates a flow chart, according to some embodiments.

### DETAILED DESCRIPTION

One advantage of the techniques disclosed herein is that they enable a third node, e.g., an external system such as an OAM or SMO system, or an AI/ML Model Training function and/or AI/ML Inference function hosted therein, to obtain from several nodes in the network, e.g., UEs and gNBs, information including feedback related to one or more (potentially many) outputs generated at different first nodes at different times, potentially time delayed, upon request, etc. These techniques also provide advantages over a solution where information, including feedback related to an output generated at a first node, is first reported (back) to and collected at the first node, and then forwarded to the third node.

Additional advantages may include, inter alia:

A reduced signaling overhead between (first and second) nodes, since the information is directly signaled to the third node.

A reduced signaling overhead between (first and second) nodes, since there is no need for a (fully specified) request for the information from a first to one or more second nodes or a fully specified request including all details related to what, when, and how to report the information.

A reduced signaling overhead between any nodes in the network because one can avoid having the same information (the same type of information from the same node, at the same time, etc.) signaled to the third node multiple times if the information is necessary for evaluating and/or learning from multiple outputs generated, e.g., actions taken, at the same time or at close time instances.

A reduced resource utilization at a first node because it does not need to collect and process the information sent by second nodes.

A (potentially) more flexible and efficient data collection policy, since the third node can request more relevant information (e.g., for AI/ML model training) when needed.

A (significantly) reduced probability that the third node erroneously associates feedback information with an output, e.g., an action, to which it does not relate or correspond to.

A faster data collection procedure, since the feedback information can reach the third node directly, instead of having to be relayed/forwarded by the first node.

Potentially a more granular and causal analysis of actions and their consequences.

A more direct observability of the AI/ML model outputs generated, or actions taken, on the system/network performance. This enables a better management/optimization of decisions concerning which actions should be taken based on which AI/ML outputs. As an example, an action A, based on a certain AI/ML output, may provide a certain benefit in terms of system performance. However, when another action B, based on the same or a different AI/ML output, is taken, the overall performance benefit generated by action A and action B are reduced with respect to when only action A was taken. Hence, knowing per output/action feedback information allows to network to decide that, e.g., it is better to take only action A based on a certain AI/ML output and leave action B, e.g., to legacy decision processes.

Another advantage of the methods described herein is that it is possible to derive an AI/ML model performance metric that determines how good/accurate certain predictions carried out by a given AI/ML Model Inference function are. One advantage of the methods is that such Model Prediction Error metric/indicator is agnostic to the type and/or implementation of the AI/ML model. Similarly, to the advantages described above, the Model Prediction Error enables an understanding of how well the AI/ML model is performing in terms of prediction of certain parameters, e.g., measurable quantities or metrics. Such understanding enables the triggering of specific actions such as to re-train, update, dismiss, and/or replace the AI/ML model. Re-training and updating could, e.g., be carried out in a selective way, only concerning certain ranges of input data and/or training data for which predictions with high Model Prediction Error are recorded. The methods allow for visibility of predictions with bad/poor performance/accuracy, so that decisions can be taken in different parts of the system/network on whether or not to take such predictions in to account for further processes and/or actions.

In some embodiments, a first node as described herein refers to a node that generates an output using an AI/ML model and uses/acts on the output or signals the output to another node, e.g., a second node. In one example, the output is an action, e.g., a UE handover, and is applied by the first node.

In some embodiments, a second node as described herein refers to any other node affected by the output of an AI/ML model, e.g., involved in or in any other way affected by actions selected and performed by the first node based on the AI/ML model. It should be clear to a person skilled in the art that such a second node may also act as a first node with respect to its AI/ML-based actions (if it also uses an AI/ML model and the method described herein is also applied to those actions).

In some embodiments, a third node as described herein is a node hosting the Model Training function and/or the Model Inference function. Such node receives feedback information related to outputs of a specific AI/ML model, e.g., actions as output of (or triggered by) the specific AI/ML model, for the purpose of monitoring/evaluating the model performance and taking appropriate actions if needed, such as re-training, updating model, or deactivating the model, or activating a model.

The terms “feedback,” “information,” “feedback information,” “information incl. feedback,” and “data” may be used interchangeably herein unless specifically stated otherwise. Data may refer to any information needed for model training or re-training/updating, e.g., training data, as well as any information needed for model performance evaluation, e.g., performance feedback/metrics.

The terms “AI/ML model” and “model” may be used interchangeably, unless specifically stated otherwise. The term “AI/ML model” may also be used as a short notation for “AI/ML model and algorithm.” It may also refer to the AI/ML model itself as well as support software package(s) or application(s) needed to run it properly, which may include, e.g., software required for data preparation/pre-processing.

A “network node” or short “node” can be a RAN node, an OAM, a Core Network (CN) node, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a cloud-based network function, a cloud-based centralized training node, a cloud-based centralized inference node, or a UE.

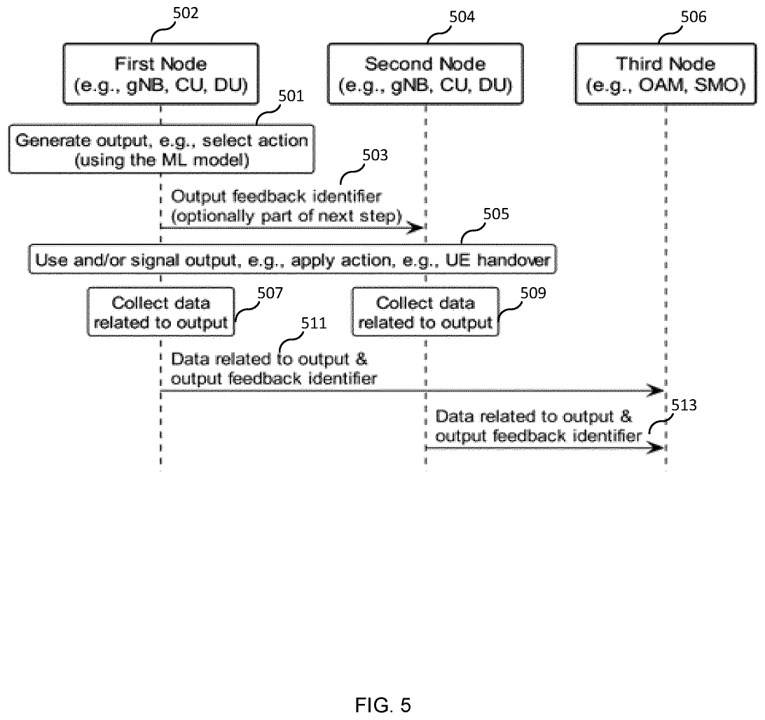

FIG. 5 illustrates a simplified flow chart, according to some embodiments. FIG. 5 illustrates signaling between a first node (502), one or more second nodes (504), and a third node (506). At 501, the first node generates an AI/ML model inference output, e.g., an AI/ML-based optimization action, using an internally deployed AI/ML model and then uses or acts on the output or signals the output to at least another node, e.g., a second node. The one or more second nodes are all other nodes or entities receiving, or involved in, or in any way affected by the output, e.g., AI/ML-based, or AI/ML-triggered action derived from the output. At 503, the first node determines/issues an output feedback identifier for the AI/ML model inference output generated at 501, and provides the output feedback identifier to the second node (optionally as part of 505). At 505, the first node uses and/or signals the output to the second node (e.g., apply an action such as a UE handover. At 507 and 509, the first node and second node, respectively, collect data related to the output. At 511 and 513, the first node and the second node, respectively, provide data related to the output (e.g., feedback) and the output feedback identifier to the third node.

### Method in the First Network Node

In some embodiments, a method is executed by the first node 502 in a communication network to enable distributed data collection related to an AI/ML model available in the first network node or a second network node 504. The first network node determines/issues an output feedback identifier for an AI/ML model inference output generated at the first node using an AI/ML model deployed/executed at the first node, the identifier uniquely identifying the specific output generated at the first node.

The output feedback identifier is transmitted to one or more second nodes 504 receiving, or involved in, or in any way affected by the output, e.g., to one or more second nodes that will/should/could report information including feedback related to the output. The first node may signal the identifier before, while, or after signaling or using/acting on the output.

The output feedback identifier is transmitted to a third node 506. The first node may signal the identifier to the third node before, when, or after reporting information including feedback related to the output, e.g., the first node may signal the identifier to the third node together with the other information, or separately.

In one embodiment, the output feedback identifier may parametrize one or more outputs generated by the execution of the AI/ML model by the first node (or by the second network node). Every time a new output is generated, e.g., a AI/ML output or action is chosen by the first node (or by the second network node), a new (identifier) value is assigned, e.g., out of a predefined or configured range of available or intended values.

The output feedback identifier may further comprise one or more information of:
(i) An indication related to AI/ML model, which was used to derive the output, optionally including AI/ML Model ID and version number,
(ii) An indication related to the use case (or the use cases) to which the AI/ML-based output, e.g., AI/ML-based action, applies/corresponds to,
(iii) An indication related to the specific output generated at the first node, e.g., an index uniquely identifying the output, provided that the output is a certain discrete output from a predefined set of outputs,
(iv) An indication related to another output generated (and/or action taken) earlier at the first node or at a different node, e.g., in case that other output or action caused this specific output,
(v) An indication related to the time (e.g., a timestamp) at which the output was generated, e.g., at which hour, day, month, and/or year or, alternatively or additionally, at which hour of the day, day of the week, etc.,
(vi) An indication related to the area (e.g., an area scope) in/for which the output was generated, e.g., in which cell, RAN node, tracking area, RAN-based notification area, PLMN, etc.,
(vii) An indication related to the first node that generated the output,
(viii) An indication related to the set of (one or more) second nodes that received or are affected by the output, e.g., an indication of a group of UEs, e.g., a UE group label, which may identify one or more UEs associated to one or a combination of the following: mobility triggered by load balancing (action), mobility triggered by coverage (i.e., signal strength/quality), or mobility triggered by energy saving (action), and/or
(ix) The slice to which the AI/ML-based output, e.g., AI/ML-based action, applies/corresponds to.

In one embodiment the first node may additionally receive from the third node a request to collect and provide the necessary data associated to the execution of an AI/ML model of the first node. As part of the request for data collection associated to the execution of an AI/ML model, the third node may indicate one or more of: (i) an output feedback identifier to be used to report the data collected for a certain AI/ML model and/or (ii) a configuration to determine an output feedback identifier to use for reporting data collected for a certain AI/ML model. In some embodiments, the first network node determines at least an output feedback identifier based on the information received by the third network node.

In some embodiments, the output feedback identifier is signaled between nodes (or entities) in a mobile network, the identifier serving as a key to identify information including feedback related to a specific output or action taken by a first node using an AI/ML model deployed and executed at the first node. The identifier may parametrize outputs or actions generated using the AI/ML model at the first node. For every new output, e.g., action, a new identifier is taken/issued by the first node. Note that, in some cases, the AI/ML model may be deployed and executed at another node, different from the first node, and the output of the AI/ML model may instead be signaled from that other node to the first node, so that use/act on the output, e.g., select and/or apply an/the action.

In some embodiments, the output feedback identifier is signaled from the first node to one or more second nodes involved in or in any way affected by the output, e.g., action, before, while, or after signaling or using/acting on the output, e.g., applying the action. The identifier is then further signaled from the first node and the one or more second nodes to the third node when reporting the necessary (and typically requested) information associated to the execution of the AI/ML model. In an alternative embodiment, the output feedback identifier may also be signaled to the third node prior to signaling information related to the execution of the AI/ML model.

In some embodiments, the action taken by a first node (e.g., a gNB) is or involves/requires the handover of multiple UEs to a second node (e.g., a gNB), and the first node is interested in global/aggregated statistics related to the performance of all handed-over UEs. In one embodiment, the output feedback identifier is signaled in each HANDOVER REQUEST and is the same for all UEs. Alternatively, at least a part of the output feedback identifier, e.g., the part comprising the indication of the group of UEs (e.g., the UE group label), is the same.

The output feedback identifier may comprise various information such as the specific AI/ML model used to generate the output, e.g., defined as AI/ML model ID and version number.

In some embodiments, that output feedback identifier is broadcasted/transmitted to all relevant nodes, not only the nodes to perform an action because of the AI/ML model output, but also nodes that are potentially affected by the action. The second node(s) will include the latest received identifier when reporting information including feedback related to the output.

### Method in a Second Network Node

Aspects of the present disclosure further include a method executed by a second node in a communication network to enable distributed data collection related to an AI/ML model available in the first network node or a second network node.

The second network node may receive from the first network node an output feedback identifier to be used to report information associated to the execution of an AI/ML model of the first node. The second network node may transmit to the first node or to a third node information associated to the execution of an AI/ML model of the first node together with the output feedback identifier.

In one embodiment, the second node may receive from the third network node a request to collect and provide the necessary data associated to the execution of an AI/ML model of the first node. As part of the request for data collection associated to the execution of an AI/ML model, the third node may indicate one or more of: (i) An output feedback identifier to be used to report the data collected for a certain AI/ML model and/or (ii) A request or a configuration to determine an output feedback identifier to use for reporting data collected for a certain AI/ML model. The second network node may determine at least an output feedback identifier based on the information received by the third network node.

### Method in a Third Network Node

Aspects of the present disclosure further include a method executed by a third node in a communication network to enable distributed data collection related to an AI/ML model available in the first network node or a second network node.

The third node receives an output feedback identifier from the first node or from a second node. The third node may receive the identifier from the first node before, when, or after the first node reports information including feedback related to the output. Thereby, it may receive the output feedback identifier together with the other information, or separately.

The third node, or an AI/ML Model Training function hosted therein, uses the output feedback identifier, received from a first node and/or one or more second nodes, which provide information including feedback related to the output obtained by the first node, e.g., using an AI/ML model deployed/executed at the first node, to identify the information received from different nodes and to associate the information with the output.

In some embodiments, the third node can request the first node and/or the one or more second nodes to collect and provide the necessary data associated to the execution of an AI/ML model. As part of the request for data collection associated to the execution of an AI/ML model, the third node may indicate one or more of: (i) Which data should be collected, such as information including feedback related to a specific AI/ML model, (ii) An output feedback identifier to be used to report the data collected for a certain AI/ML model, (iii) A configuration to determine an output feedback identifier to use for reporting data collected for a certain AI/ML model, such a range of output feedback identifiers, or a set of parameters to determine an output feedback identifier interpretable by the third network node. In other embodiments, the third node may send the request only to the first node, which may in turn forward the request to one or more second nodes as needed. The one or more second nodes then collect and provide the required data to the third node.

### Output Feedback (Identifier) Embodiments

In some embodiments, the first node is the node that performs the AI/ML model inference and the node that takes an action based on AI/ML model outputs. In some embodiments, the first node may not be the node that performs the AI/ML model inference, but may simply use AI/ML model inference outputs, e.g., received from another/external node, to derive actions. Embodiments described herein disclose how to signal across multiple nodes information associated with the execution of an AI/ML model executed by/at a first node, wherein such information may include information related to the output of the AI/ML model, performance feedback information, etc.

An output of an AI/ML model may represent an action associated to a RAN functionality, such as a UE handover, predicted by the AI/ML model and applied/taken by a first node or the second node. In other examples, the output of the AI/ML model may represent information associated with one or more actions that can be taken by the first or second node, such as an action value, so that an action may be selected based on the output of the AI/ML model. In yet other cases, the output of the AI/ML model may represent one or more predictions of a measurable quantity, or a metric, which could be used by a first node and/or signaled to a second as such. In either case, data such as feedback information from one or more RAN nodes is needed, e.g., by the third node, for the purposes mentioned above.

In one example, an action of a (source) RAN node is or leads to a handover of a UE to another (target) RAN node. Such action is based on AI/ML model outputs generated by a RAN node running AI/ML model inference. In that case, the RAN node running AI/ML model inference is the first node, and at least the target RAN node and UE are second nodes.

In one example, actions may consist of determining parameter values for radio transmission/reception, such as allocation of radio resources, allocation of link adaptation parameters (such as modulation order, rank, MCS index, etc.). In another example, actions may consist of mobility related decision, such as handover of user devices from one radio cell to another, load balancing decisions, energy saving configurations (for network nodes or user devices), etc.

In case the output of the AI/ML model is a prediction of a measurable quantity or metric, for a certain time or time window, the third node can request from (first and second) nodes one or more model performance metrics, e.g., a mean absolute error, or a model prediction error percentage. In one embodiment, the first node signals the output to at least one second node, which can measure the predicted quantity or metric at a later point. In one example, the first node hands over at least one UE to the second node and further signals a prediction of the traffic volume that the at least one UE will generate within the next X seconds (e.g., in the Handover Preparation signaling). The second node can then measure the traffic volume generated by the at least one UE and calculate at least one model performance metric based on the received prediction and measured value for one or more UEs. The second node can further signal the at least one model performance metric to the third node, e.g., based on a corresponding request from the third node, optionally forwarded by the first node.

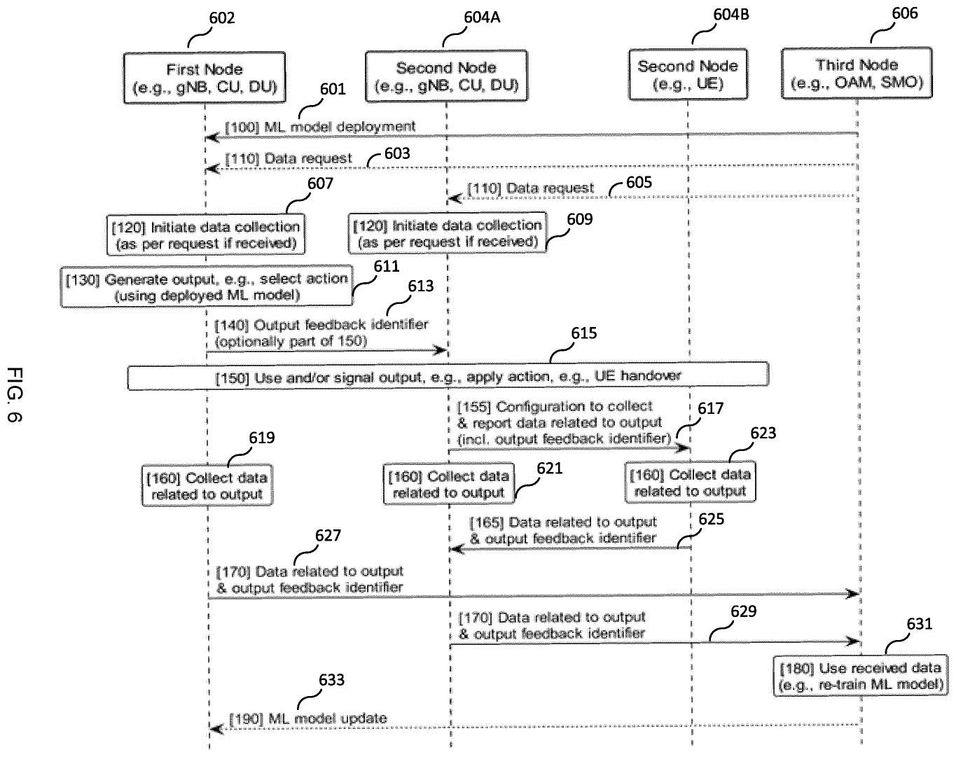

FIG. 6 illustrates a flowchart, according to some embodiments. In some embodiments, FIG. 6 illustrates additional steps showcasing how the techniques disclosed herein enable an efficient collection of distributed data in the RAN. Steps 611, 613, 615, 619, 621, 627, and 629 are also shown in FIG. 5. Steps 603, 605, 613, 627, and/or 629 may involve changes in 3GPP standards. In some embodiments, steps 601, 603, 605, 607, and 609, and steps 631 and 633, on the other hand, are potentially optional.

FIG. 6 illustrates signaling between a first node (602), one or more second nodes (605A-B), and a third node (606).

Step 601 illustrates AI/ML model deployment. It may be assumed that a first node uses an ML model, e.g., an RL agent, to select and perform one or more actions that involve or in any way affect one or more second nodes. It is also assumed that the ML model is trained and re-trained/updated externally, namely by or at a third node, e.g., an external system such as an OAM or SMO system. This means that the AI/ML Model Training function, which is responsible for training and updating the ML model, is located/hosted at the third node (606). Another option is that the AI/ML model is retrained at a node that hosts the AI/ML Model Inference function, in which case steps 627 and 629 will be signaled to such node. The ML model must thus be deployed in the first node before it can be used (step 601). In one embodiment, the third node may assign and signal to the first node part of the output feedback identifier, which is later (in step 611) issued by the first node for each output generated at, e.g., action taken by, the first node using the deployed ML model. For example, the third node may assign and signal to the first node a prefix or suffix to be added to the output feedback identifiers. In another embodiment, alternatively or additionally, the third node may signal to the first node (and optionally one or more second nodes) such part of an output feedback identifier in the feedback/data request (in steps 603, 605). In another embodiment, the third node can (pre-)configure the first node (and optionally the one or more second nodes) with a structure for the output feedback identifier. In another embodiment, the third node can (pre-)configure the first node (and optionally one or more second nodes) with a plurality of output feedback identifiers together with conditions as to when to use them.

Steps 607 and 609 illustrate performance monitoring. After receiving an optional feedback/data request from the third node (603, 605), the first and one or more second nodes requested or configured to provide information including feedback related to one or more outputs generated at, e.g., actions taken by, the first node, e.g., using a specific AI/ML model in a specific version, start monitoring the corresponding performance metrics or indicators, and collect the information as per request and/or 3GPP standards if applicable. For a second node, the monitoring may, in a first step, be limited to observing/checking whether it receives a certain output feedback identifier and may thus be required to collect and report the information. If a second node is a UE, it may be that the UE is configured (to monitor performance and collect feedback) by the first node or at least one second node, e.g., a gNB, which is requested to report information including feedback related to outputs/actions involving or affecting the UE, e.g., if the outputs/actions are chosen using a specific AI/ML model in a specific version.

Step 611 illustrates generating an AI/ML output. As per the example use cases, it is assumed that the first node uses the AI/ML model trained or updated at the third node (deployed in step 601) to generate an output, e.g., select an action, with the aim of optimizing or improving the RAN operation and procedures toward a certain objective, e.g., RAN energy saving. The first node may be requested (603) to provide information including feedback related to the output, e.g., because the output was generated using a specific AI/ML model in a specific version. Alternatively, the first node can be configured to provide the feedback information in another way, in which case a feedback/data request is not needed. Either way, the first node issues an output feedback identifier or alike at step 611, which uniquely identifies the exact output generated at the first node for which feedback information should be provided, by the first node and/or a second node, to the third node. In one example, the first network node may require the second network node, e.g., a UE, to provide feedback information back to the first network node based on the identified output. The first network node may then forward the received feedback information, possibly together with the output feedback identifier, to the third network node.

The first node may issue an output feedback identifier for an output generated at, e.g., an action taken or to be taken by the first node based on an AI/ML model deployed/executed at the first node, the identifier uniquely identifying a specific output generated at the first node. The identifier may further comprise one or more information of: (i) An indication related to AI/ML model, which was used to derive the output, optionally including AI/ML Model ID and version number; (ii) An indication related to the use case (or the use cases) to which the AI/ML-based output, e.g., AI/ML-based action, applies/corresponds to; (iii) An indication related to the specific output generated at the first node, e.g., an index uniquely identifying the output, provided that the output is a certain discrete output from a predefined set of outputs; (iv) An indication related to another output generated (and/or action taken) earlier at the first node or at a different node, e.g., in case that other output or action caused this specific output; (v) An indication related to the time (e.g., a timestamp) at which the output was generated, e.g., at which hour, day, month, and/or year or, alternatively or additionally, at which hour of the day, day of the week, etc.; (vi) An indication related to the area (e.g., an area scope) in/for which the output was generated, e.g., in which cell, RAN node, tracking area, RAN-based notification area, PLMN, etc.; (vii) An indication related to the first node that generated the output; (viii) An indication related to the set of (one or more) second nodes that received or are affected by the output; and/or (ix) The slice to which the AI/ML-based output, e.g., AI/ML-based action, applies/corresponds to.

The output feedback identifier may parametrize outputs of an AI/ML model, e.g., obtained with the AI/ML model at the first node. For every new output generated, e.g., action selected, a new identifier is determined/issued by the first node.

In one embodiment, the first node may further receive a Feedback/Data Request message (step 603) from the third node comprising a request or a configuration to provide output feedback identifier(s) structured in a certain way and/or comprising certain information. The structure of and/or information comprised in the output feedback identifier(s) may therefore depend on a request or a configuration provided by the third network node.

Step 613 illustrates signaling of the output feedback identifier. The first node signals the output feedback identifier to one or more second nodes involved in or in any way affected by the output generated in step 611, i.e., to one or more second nodes that will/should/could collect and report information including feedback related to the output, e.g., neighboring gNBs and UEs. In one example, an action taken by a (first) gNB based on the output is a handover of a UE to a (second) neighboring gNB. Here, the set of second nodes comprises at least the neighboring (target) gNB and the UE to be handed over, but it may also comprise other UEs served by either the first gNB or the (second) neighboring gNB. The exact definition of the set of second nodes depends on the AI/ML-enabled use case and AI/ML model design and must be known or signaled to the first node. The first node may signal the output feedback identifier before, while, or after using and/or signaling the output, e.g., applying an action, e.g., UE handover. In one embodiment, the first node may signal the output feedback identifier in the HANDOVER REQUEST message during the Handover Preparation procedure over the Xn interface. This means that, in one example, step 613 may be part of step 615.

Steps 603 and 605 illustrate signaling of a feedback/data request from a third node. In some embodiments, a third node may use a feedback/data request mechanism to request, from multiple nodes in the network, information associated to the execution of an AI/ML model, e.g., executed by/at a first node, wherein such information may include information related to ab output of the AI/ML model, performance feedback, network/system KPI, etc.

To train, re-train/update or monitor the performance of an ML model, the third node, or the AI/ML Model Training function located/hosted therein, must first obtain new (training) data to generate new training samples/examples, which are typically called experiences in Reinforcement Learning (RL). Such an experience often comprises a tuple (s, a, r, s′), where s is the state of the environment before the action was applied, a is the applied action, r is the received reward, and s′ is the state of the environment after the action was applied. To generate new experiences, the AI/ML Model Training function must know all information including feedback that define the states s and s′, as well as the reward r received for taking action a given state s, which then caused the state transition from s to s′. This means that the third node must obtain all information including feedback related to an action taken by the first node, i.e., the third node must receive all information defining the tuple (s, a, r, s′). To achieve this, the third node may, e.g., request the information from the first and one or more second nodes (steps 603, 605). Such requests may include all essential details related to what, when, and how to report the information to the third node, or, alternatively or additionally, part of the details may be defined in 3GPP standards. Alternatively, the first and second nodes might have been configured to report feedback to the third node without the reception of an explicit request. This implies that a Feedback/Data Request message (603, 605) may not always be needed to trigger further steps leading to the signaling of feedback data/information to the third node.

In one embodiment, if the third node only aims to monitor/evaluate the performance of the ML model, the third node may only need to receive the reward r, or all information defining the reward r, and thus accordingly request only that information. Alternatively or additionally, the third node may request certain information apart from/independent of the reward r, or the information defining the reward r, e.g., certain network/system KPI, that enable monitoring and/or evaluation of the network/system performance subject to the usage of a certain AI/ML model.

It is understood that the first node is able to employ the ML model correctly, i.e., it has access to the state s at the time of selecting action a. If, in order to have the state s, the first node needs certain information from the second node, it is assumed that the first node would request and receive the information from the second node by suitable means, even though this is not show in FIG. 6.

For supervised learning (SL), or another AI/ML approach (besides RL), a training sample may take the form of a tuple (i, m), where i is an input and m is a measurement, which is the ground truth for the output of the ML model. If the third node aims to train or re-train/update the ML model, it must receive all information defining the tuple (i, m). If instead the third node aims to monitor/evaluate the performance of the ML model, it must receive all information defining the tuple (i, m, p), or at least all information defining the tuple (m, p), where p is a prediction, i.e., a specific AI/ML model inference output, generated at a first node. Alternatively or additionally, the third node may directly receive one or more AI/ML model performance metrics, e.g., a model prediction error (percentage). As before, it is assumed that the third node can request the information.

In one embodiment, the third node can request or configure the first node and/or second node(s) and/or UE(s) (via the first network node and/or second network nodes(s)) to provide output feedback identifier(s) structured in a certain way.

In one variant, the output feedback identifier is set to a fixed value, set by the third network node. Besides, one or more or any combination of the following options is possible: (i) An identifier of a job initiated by OAM, (ii) An identifier associated to a (re-)training or updating process, (iii) An identifier of an AI/ML Model (e.g., a Model ID and version number), (iv) An identifier of an AI/ML Model vendor, (v) An identifier of a use case, and/or (vi) An identifier for an output or action (in case the third node is only interested in one or more specific outputs or actions).

In another variant, an output feedback identifier comprises: (i) A fixed common part (i.e., a portion of the feedback is common to all the parties involved in or in any way affected by the output or action), and (ii) A dynamic part (determined—at run time—by the network nodes and/or UEs involved in or in any way affected by the output or action). The common part can comprise one of more or any combination of the options listed for the case of feedback identifier set to a fixed value. The dynamic part can be one or more or any combination of the following options: (i) An identifier of the network node/UE affected by the output or action, (ii) An identifier of the role played by the node with respect to the output or action (e.g., source/target), (iii) A random identifier determined by the network node or UE, (iv) A UE context ID, (v) A timestamp, (vi) An indication (e.g., a tag or Boolean) to indicate whether the output, e.g., an action or an action selected based on the output, was successful or failed, (vii) One or more indications of performance related to the output or action, e.g., throughput, packet loss, energy efficiency/consumption, delay, etc., (viii) One or more indications of RAN-visible QoE metrics and RAN-visible QoE values associated to the output or action, e.g., during a UE mobility event, and/or (ix) An indication whether the feedback is periodic, etc.

In another example the identifier can have a long form and a truncated form and depending on the network conditions and the resource status of the UE for instance the appropriate form is used.

In a mobility-related example, the OAM requests the first and second network nodes to provide an output feedback identifier for mobility events occurring between such network nodes. The OAM sends as part of the request for receiving feedback information, a request—to one or more of the network nodes and UEs involved in the mobility procedures—to provide an output feedback identifier containing at least a timestamp associated to the action (e.g. when handover preparation started, when handover execution was completed), a tag to indicate whether the handover preparation and execution was successful, an indication of whether the handover was incoming or outgoing, or equivalently, if the network node was the source or the target RAN node for the handover.

The OAM can provide an initial version of the output feedback identifier, containing a fixed (common) part comprising one or more of: A use case identifier (e.g., pointing to “mobility optimization”), an AI/ML Model ID, an AI/ML process ID (e.g., to later reconstruct that the requested feedback is being requested to train/re-train a certain AI/ML model).

The source RAN node and/or the target RAN node and/or the UE affected by an output, e.g., involved in an action selected based on the output, send to the OAM (the UE, e.g., via the target RAN node) their output feedback identifier, either during, upon, or after completion of the action. For example, the source RAN node can include in its feedback the timestamp when handover preparation was initiated, the target RAN node can include in its feedback the timestamp corresponding to the handover completion time and a Boolean to indicate whether the handover was successful or not, the UE can include in its feedback the layer 1 or application layer throughput experienced before, during, and/or after the UE mobility event.

In another example, the first network node and/or the second network nodes are involved in a MR-DC procedure (e.g., SN Addition or PSCell Change).

In one embodiment, the third node can be a node, or an entity, located outside of and therefore separate from an OAM or SMO system, but responsible for collecting the data.

In another embodiment related to the above embodiments, the third node (pre-)configures the first node with a specific structure of the output feedback identifier with the understanding that the specific structure will be followed/used during all possible interactions and AI/ML-related procedures between first, second, and third nodes. The first node can fill a part of the output feedback identifier itself and upon interaction with one or more second nodes, the second nodes will fill the rest of the output feedback identifier. In a related example, the OAM after (pre-)configuring the first node with the output feedback identifier as explained below, does not need to send a specific request in order to receive (back) the output feedback identifier.

In another embodiment, the third node can (pre-)configure the first node one or more second nodes with a plurality of output feedback identifiers together with conditions as to when to use them. The conditions can include signaling conditions, load/traffic conditions, resource status of the nodes etc. Depending on the conditions, the first and second nodes can determine the appropriate output feedback identifier to use. The first node can then signal the output feedback identifier to be used to the second nodes and the second nodes can respond. In the case a second node can use the proposed output feedback identifier, the second node acknowledge this in its response. Otherwise, the second node can reject with an appropriate cause value and instead suggest another output feedback identifier that can be used.

In a further embodiment, the identifier is broadcasted/transmitted to all relevant nodes, that is all the nodes that are (potentially) affected by the output generated at the first node, or, e.g., actions taken by the first node based on the output generated at the first node. The second nodes will replace their parametrized identifier by the latest received identifier before reporting information including feedback related to the output.

Step 615 illustrates use and/or signal of the output. In this step, the output, e.g., generated at first node (in step 611) using the AI/ML model (trained or updated at the third node and deployed and executed at the first node, as per example considered), is used and/or signaled. In a specific example described herein, an action is selected and applied by the first node considering or based on the output of the AI/ML model. When signaling the output, or applying the action, the first node can request to one or more second nodes to transmit the output feedback identifier to the third node. For example, as part of a handover preparation triggered by the AI/ML model, the source RAN node (first node) can send to the target RAN node (second node), and/or to the UE via the source RAN node, the output feedback identifier associated to the initiated action, and request the target RAN node, and/or to the UE, to propagate the output feedback identifier to the third node. Here, the first/source RAN node could send the output feedback identifier to the second/target RAN node as part of the Handover Preparation signaling in the HANDOVER REQUEST message. This would implicitly (or explicitly by means of a separate indication) request the target RAN node to send the output feedback identifier to the third node when the action is completed or failed. The second RAN node after determining handover successful/failed completion can send the output feedback identifier to the third node.

In the case where the third node has (pre-)configured the first RAN node with a structure for the output feedback identifier, when the second RAN node receives the identifier from the first RAN node with part of the identifier empty, the second RAN node will understand that it needs to complete the identifier and then send the identifier to the third node. In this case, it is also possible that there are different versions of the identifier, e.g., a shorter and a longer version. In that case, the RAN nodes can exchange the version of the identifier that they support/use at Xn Setup. In that way, the first RAN node will know which identifier the second RAN node supports and act accordingly. In another example, the first node can send the identifier it uses to the second node with an NG-RAN node Configuration Update message. It can also be that, during the AI/ML procedure, the first node decides to change the version of the identifier used, e.g., if signaling conditions get worse and/or a UE can't support the full identifier, so that there is a need to start using the truncated form. In that case, the first node informs the second node(s) about the change with an NG-RAN node Configuration Update message.

In one variant, during the handover execution phase, a UE receives from a first (source) RAN node an RRC message (e.g., an RRC Reconfiguration message) comprising an output feedback identifier or another identifier-associated to the output feedback identifier and encoded with a lower amount of bits to optimize the interference over the air interface-which the UE can return to a second (target) RAN node when the handover is completed and the UE is connected to the target RAN node or later. The output feedback identifier (or the corresponding shortened version of that identifier) can be derived only by the source RAN node, or only by the target RAN node (and sent to the UE via the source RAN node as part of the Handover Command prepared by the target RAN node and comprised in an RRC Reconfiguration message), or both.

Steps 619, 621, 623, and 625 relate to collection of data related to the output. In these steps, the relevant performance metrics/indicators are monitored, and the required information is collected as per feedback/data request from the third node and/or 3GPP standards as discussed above. If part of the required information needs to be, e.g., can only be, collected and reported by a UE, the second node can configure the UE accordingly in step 617. As part of this configuration signaling step/procedure, or in a separate signaling step/procedure, the second node can also signal the output feedback identifier to the UE. The UE can then collect the required data related to the output (in step 623) and signal/report that data to the second node in step 625, potentially time delayed (or even upon separate request). In connection with the data, together or separately, the UE may also signal the output feedback identifier (back) to the second node. In one variant of the method there is no second RAN node. In that case, the data collection steps are carried out between the first node and the UE, as discussed below. The data collection from the UE may, in one example, be carried out using a Minimization of Drive Tests (MDT)/Trace framework for the collection of training data, input data, and feedback information for AI/ML models. A 3GPP Technical Report (TR) 37.817 has been produced as an outcome of the Study Item (SI) “Enhancement for Data Collection for NR and EN-DC” defined in 3GPP RP-201620, and MDT has been specified for both LTE and NR in TS 37.320.

At steps 627 and 629, information is reported to the third node with the output feedback identifier. After monitoring the relevant performance metrics/indicators and collecting the required information as per feedback/data request from the third node and/or 3GPP standards as stated above, the first node as well as the one or more second nodes each signal the output feedback identifier issued by the first node to the third node. The first node as well as the one or more second nodes may signal the output feedback identifier to the third node before, when, or after reporting information including feedback related to the output, i.e., they may signal the output feedback identifier to the third node together with the other information, or separately.

At 631, the third node, or the AI/ML Model Training function and/or the AI/ML Model Inference function located/hosted therein, uses the output feedback identifier received from the first node and the one or more second nodes in connection with the information including feedback to identify the information and associate it to the output generated in step 611 and used/signaled in step 615. The third node, or the AI/ML Model Training function and/or the AI/ML Model Inference function located/hosted therein, can thus merge/fuse all information related to the specific output generated at the first node using a specific ML model and version, i.e., at/in the specific time/area.

In some embodiments, steps 631 and 633 are optional. At step 631, the third node uses the feedback. In this step it is assumed that the third node, or the AI/ML Model Training function located/hosted therein, merged/fused all the required information including feedback related to the output. It may then use the information to evaluate the ML model performance and/or re-train/update the ML model (deployed in step 601). With respect to the latter, it can use the merged/fused information to generate one or more new training data/experiences in the form of tuples (s, a, r, s′) in case of RL, or tuples (i, m) in case of SL, as described above. These can then be used to re-train/update the ML model, e.g., the RL agent, to improve the ML model performance thus enabling the first node to produce better outputs, e.g., select better actions, i.e., to further optimize or improve the RAN operation and procedures.

Step 633 updates the AI/ML model. In some embodiments, step 633 resembles step 601 to a large extent. It is assumed that the third node, or rather the AI/ML Model Training function and/or the AI/ML Model Inference function located/hosted therein, used the received information including feedback to re-train/update the ML model deployed in step 601. The third node may decide to signal to or deploy at the first node the updated ML model, or a new ML model, so that the updated ML model, or the new ML model, can be used by the first node. This enables the first node to produce better outputs, e.g., select better actions, i.e., to further optimize or improve the RAN operation and procedures.

In one embodiment, the third node may also assign and signal to the first node a new prefix/suffix for the output feedback identifier, or, alternatively or additionally, another part of the output feedback identifier, which is from then on issued by the first node for each action taken by the first node using the updated ML model (or the new ML model).

### Variant—No Second RAN Node Involved/Affected

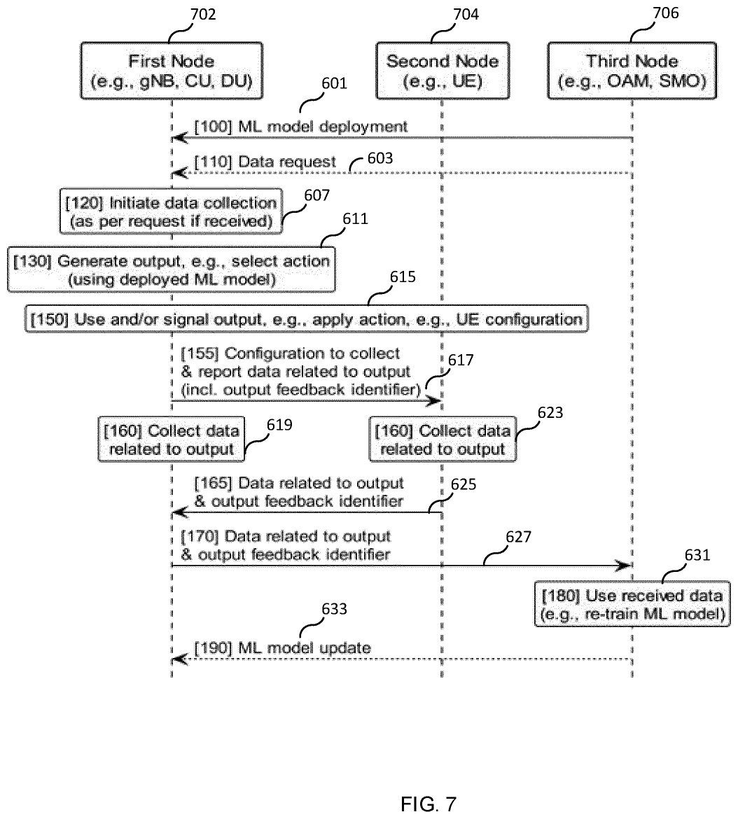

FIG. 7 illustrates a flow chart according to some embodiments. FIG. 7 illustrates a variant where no second RAN node, e.g., neighboring gNB, is involved in or affected by the AI/ML model or the output of the AI/ML model, e.g., involved in or affected by an action selected and performed by the first node (702) based on the AI/ML model or the output of the AI/ML model. In this case, the type of second node involved in or affected by the AI/ML model or the output of the AI/ML model is a UE (704). Thus, step 613 shown in FIG. 6 does not apply, i.e., it is skipped. Moreover, if a UE is configured to collect and report data related to the output in step 617, it will/must signal/report such data to the first node (702) in step 625. The other steps described above in connection with FIG. 6 apply correspondingly, including with respect to the third network node (706), but without involving a second RAN node.

### Variant—Initial Feedback/Data Request Sent to First RAN Node Only

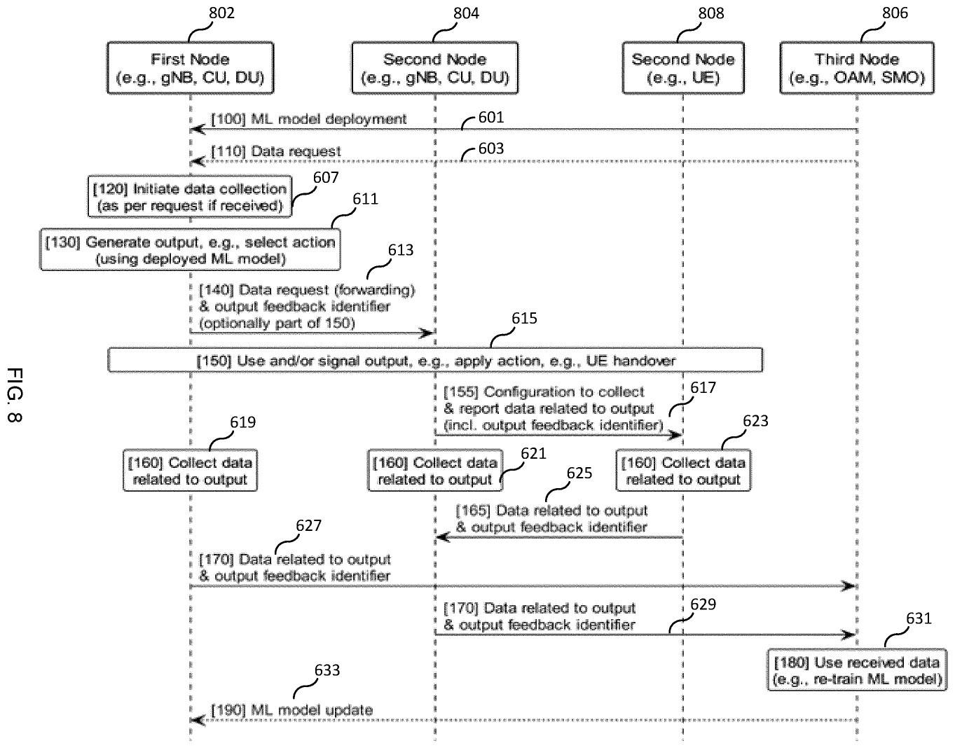

FIG. 8 illustrates a flow chart according to some embodiments. FIG. 8 depicts a variant where the initial feedback/data request is sent from the third node (806) to the first node only (802), and thus not to a second node (804). In that case, the first node forwards the feedback/data request to all relevant second (RAN) nodes (804) in step 613. In one embodiment, the feedback/data request is simply forwarded/relayed by the first node as received from the third node. In another embodiment, the first node sends its own feedback/data request to the relevant second RAN nodes. In this case, the first node may have either (slightly) modified the request received from the third node or created a new (different) request based on the request received from the third node. In the latter case, the first node may use a different data request mechanism/procedure, e.g., designed/intended for inter RAN node signaling, e.g., over Xn. In either case, the first node signals the output feedback identifier to the relevant second RAN nodes in step 613 or optionally in step 615. The output feedback identifier may be signaled together with the feedback/data request, or separately. All other aspects described above apply correspondingly and the other steps described above apply analogously.

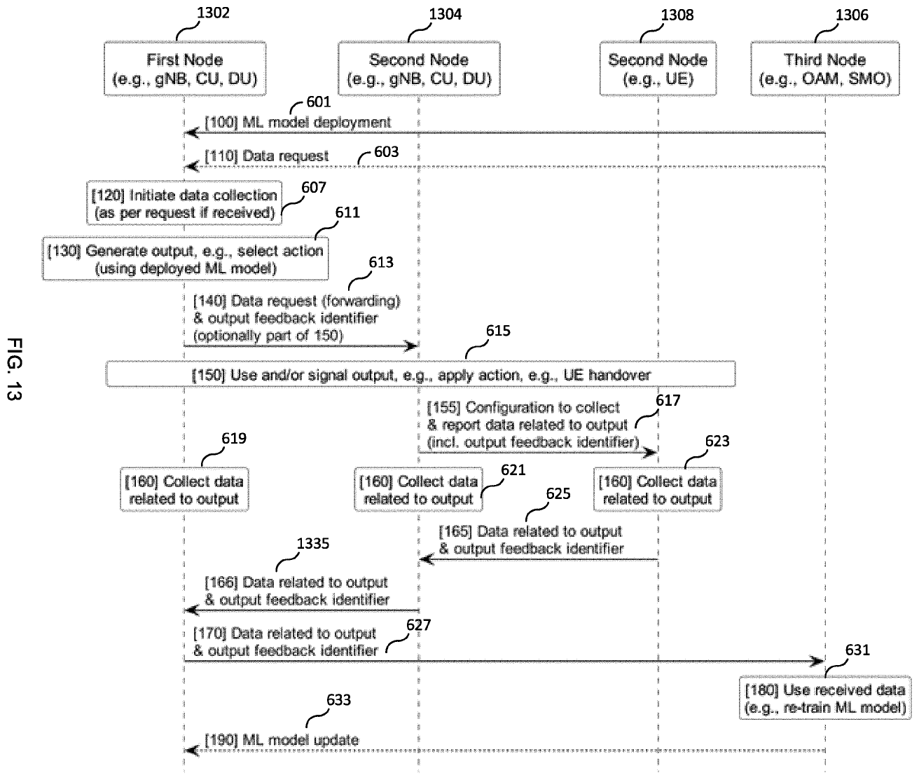

FIG. 13 illustrates a flow chart, according to some embodiments. FIG. 13 is a subvariant of the flow chart shown in FIG. 8, where the first node 1302 signals in step 613 to the relevant second (RAN) nodes 1304 that the collected information should be sent to the first node 1302, as shown in step 1335 of FIG. 13. In one embodiment, the third node 1306 explicitly signals in the feedback/data request in step 603 that the first node 1302 should collect all the relevant data before signaling it to the third node in step 627. Alternatively, the request to collect the information including feedback from the second (RAN) nodes can be implicit in the signaling in step 603. The other steps in FIG. 13 described previously apply correspondingly but considering that the second (RAN) nodes 1304 signal the data related to the output and the output feedback identifier to the first node 1302 instead of, or in addition to, the third node 1306.

### Model Prediction Error Embodiments

In some embodiments, a node derives predictions of a certain parameter, metric, or measurable quantity, via an AI/ML-supported process, e.g., via an AI/ML model, or receives such predictions from another node, and can calculate the prediction error in a way that is agnostic to the type of AI/ML model or AI/ML model implementation used to carry out the prediction. Such calculation is carried out by comparing predictions to the corresponding ground truth, e.g., measurements of the parameter, metric, or quantity that was predicted. This means that the “ground truth” is intended as an actual/measured value of the predicted parameter, metric, or quantity at the time or during the period when the prediction was assumed to be valid.

One example of an AI/ML model implementation independent way of providing AI/ML model performance feedback in the form of Model Prediction Error is the equation (1) below:

$$Model Prediction Error \% = \frac{( {\sum }_{i = 1}^{T otNumOutputs} \frac{\vert {P}_{i} - {M}_{i} \vert}{{M}_{i}} )}{T o t N u m O u t p u t s} \times 100 \qquad ( 1 )$$

Where P_i refers to the prediction output value for a specific parameter (referred to as p above); M_i refers to the ground truth for P_i (referred to as m above); and TotNumOutputs is the total number of prediction output values P_i that is considered when calculating the Model Prediction Error, where TotNumOutputs≥1.

To achieve the above, the node deriving the predictions, e.g., an NG-RAN node hosting an AI/ML Model Inference function, or a node receiving such predictions from another node, needs to acquire the ground truth corresponding to those predictions, e.g., by means of performing or requesting relevant/suitable measurements. It is herein assumed that the Model Prediction Error can be determined only for predictions of a measurable quantity. The person skilled in the art may acknowledge that the method can be applied to any sort of AI/ML model inference output provided that the difference between the AI/ML output and ground truth can be quantified.

As an example of the latter case, with respect to the mobility case, the output or action (such as “the best target cell is X”) may be a prediction of the target cell where a UE will handover to in a Conditional Handover (CHO) procedure. In such case, there are several candidate target cells and there may be a candidate target cell which is the best handover target cell within a certain time interval. However, the same handover target cell may no longer be the best handover target cell after a certain time, e.g., as the traffic/load changes in the cells. Then the best handover target cell may be a different cell. In this example, the source node prepares candidates target cells X, Y, Z for CHO (i.e., the action is “prepare”). After the CHO is completed or failed, the source node can compare the number of times candidate target cell X was used (e.g., defined as |Pᵢ−Mᵢ|=0) or failed to be used (e.g., defined as |Pᵢ−Mᵢ|=1) with the number of times candidate target cell X was prepared due to prediction or TotNumOutputs. Therefore, such quantifiable comparison can be used to derive a Model Prediction Error in the case where the prediction is carried out on an action.

The Model Prediction Error enables performance assessment and comparison of different AI/ML models during or after training if they are trained in the same environment) as well as performance monitoring of AI/ML models during inference. If, for example, the target environment experiences measurable drift, e.g., data and/or concept drift, an AI/ML model decay (i.e., the AI/ML model performance decreases) can be detected as increase in Model Prediction Error.

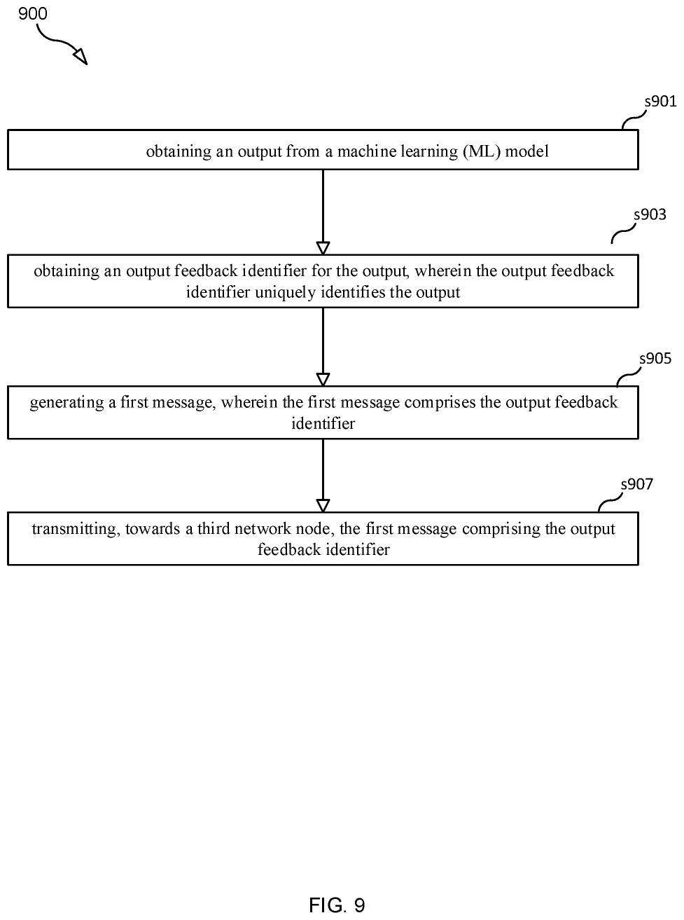

FIG. 9 illustrates a method 900, according to some embodiments. Method 900 is a computer-implemented method performed by a first network node in a radio access network (RAN). Step s901 of the method includes obtaining an output from a machine learning (ML) model. Step s903 of the method includes obtaining an output feedback identifier for the output, wherein the output feedback identifier uniquely identifies the output. Step s905 of the method includes generating a first message, wherein the first message comprises the output feedback identifier. Step s907 of the method includes transmitting, towards a third network node, the first message comprising the output feedback identifier.

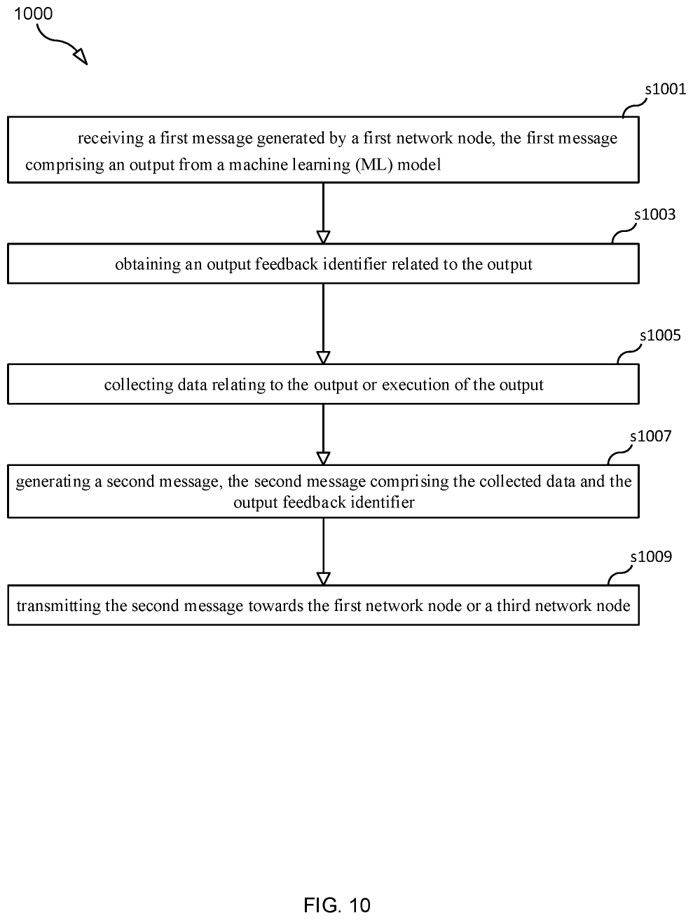

FIG. 10 illustrates a method 1000, according to some embodiments. Method 1000 is a computer-implemented method performed by a second network node. Step s1001 of the method includes receiving a first message generated by a first network node, the first message comprising an output from a machine learning (ML) model. Step s1003 of the method includes obtaining an output feedback identifier related to the output. Step s1005 of the method includes collecting data relating to the output or execution of the output. Step s1007 of the method includes generating a second message, the second message comprising the collected data and the output feedback identifier. Step s1009 of the method includes transmitting the second message towards the first network node or a third network node.

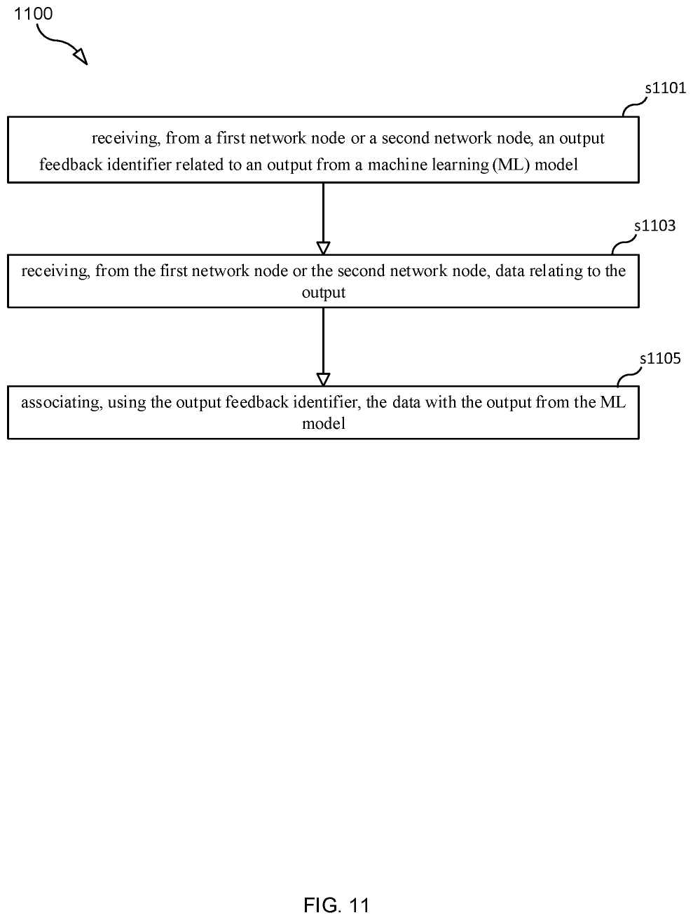

FIG. 11 illustrates a method 1100, according to some embodiments. Method 1100 is a computer-implemented method performed by a third network node. Step s1101 of the method includes receiving, from a first network node or a second network node, an output feedback identifier related to an output from a machine learning (ML) model. Step s1103 of the method includes receiving, from the first network node or the second network node, data relating to the output. Step s1105 of the method includes associating, using the output feedback identifier, the data with the output from the ML model.

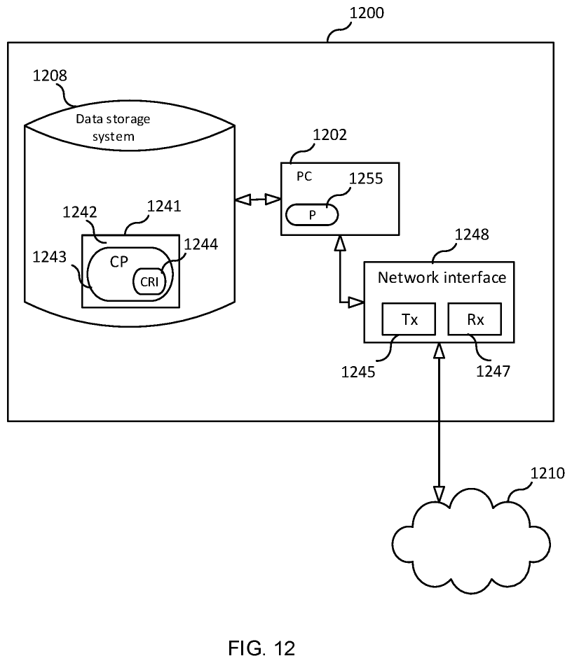

FIG. 12 is a block diagram of a network node 1200 according to some embodiments. In some embodiments, computing device 1200 may comprise one or more of the components of a network node, such as the first, second, and/or third network node as described herein. As shown in FIG. 12, the network node may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like); communication circuitry 1248, comprising a transmitter (Tx) 1245 and a receiver (Rx) 1247 for enabling the device to transmit data and receive data (e.g., wirelessly transmit/receive data) over network 1210; and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes the apparatus to perform steps described herein (e.g., steps described herein with reference to the flow charts). In other embodiments, the apparatus may be configured to perform steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] 3GPP TR 37.817 (v17.0.0): “Study on Enhancement for Data Collection for NR and EN-DC” (Release 17).

### Abbreviations

3GPP 3rd Generation Partnership Project
5G 5th Generation
5GC 5G Core network
5GS 5th Generation System
AI Artificial Intelligence
AMF Access and Mobility Management Function
AR Augmented Reality
AS Access Stratum
ASN.1 Abstract Syntax Notation One
AT Attention
CGI Cell Global Identity
CN Core Network
CP Control Plane
CU Central Unit
CU-CP Central Unit Control Plane
CU-UP Central Unit User Plane
DASH Dynamic Adaptive Streaming over HTTP
DC Dual Connectivity
DL Downlink
DNS Domain Name System
DU Distributed Unit
E-CGI E-UTRAN CGI
EN E-UTRAN-NR
eNB Evolved Node B/E-UTRAN Node B
en-gNB A gNB acting as a secondary node in an EN-DC scenario (i.e. in a DC scenario with an eNB as the master node and a gNB as the secondary node.
EPC Evolved Packet Core
EPS Evolved Packet System
E-UTRA Evolved UTRA
E-UTRAN/EUTRAN Evolved UTRAN
gNB Radio base station in NR
HSS Home Subscriber Server
HTTP Hypertext Transfer Protocol
IAB Integrated Access and Backhaul
ID Identifier/Identity
IE Information Element
LTE Long Term Evolution
MAC Medium Access Control
MCC Mobile Country Code
MCE Measurement Collection Entity/Measurement Collector Entity
MDT Minimization of Drive Tests
ML Machine Learning
MME Mobility Management Entity
MNC Mobile Network Code
MTSI Multimedia Telephony Service for IMS
N3IWF Non-3GPP Interworking Function
NG Next Generation
NG The interface between an NG-RAN and a 5GC.
NGAP NG Application Protocol
NG-RANNG Radio Access Network
NID Network identifier
NR New Radio
NWDAF Network Data Analytics Function
O&M Operation and Maintenance
OAM Operation and Maintenance
PDCP Packet Data Convergence Protocol
PDU Protocol Data Unit
PLMN Public Land Mobile Network
QMC QoE Measurement Collection
QoE Quality of Experience
RAN Radio Access Network
RAT Radio Access Technology
RL Reinforcement Learning
RLC Radio Link Control
RNC Radio Network Controller
RRC Radio Resource Control
RVQOE RAN Visible QoE
S1 The interface between the RAN and the CN in LTE.
S1AP S1 Application Protocol
SL Supervised Learning
SMO Service Management and Orchestration
S-NSSAI Single Network Slice Selection Assistance Information
SRB Signaling Radio Bearer
TA Tracking Area
TCE Trace Collection Entity/Trace Collector Entity
TNGF Trusted Non-3GPP Gateway Function
TWIF Trusted WLAN Interworking Function
UDM Unified Data Management
UE User Equipment
UMTS Universal Mobile Telecommunication System
URI Uniform Resource Identifier
URL Uniform Resource Locator Uniform Resource Locator
UTRA Universal Terrestrial Radio Access
UTRAN Universal Terrestrial Radio Access Network
WLAN Wireless Local Area Network
Xn The interface between two gNBs in NR.
XnAP Xn Application Protocol

1. A computer-implemented method performed by a first network node in a radio access network (RAN), the method comprising:
obtaining an output from a machine learning (ML) model;
obtaining an output feedback identifier for the output, wherein the output feedback identifier uniquely identifies the output;
generating a first message, wherein the first message comprises the output feedback identifier; and
transmitting, towards a third network node, the first message comprising the output feedback identifier.

2. The method of claim 1, further comprising:
collecting data relating to the output from the ML model, wherein the first message further comprises the collected data.

3. The method of claim 1, further comprising:
identifying a second network node receiving, involved in, or affected by the output;
generating a second message comprising the output feedback identifier; and
transmitting, towards the second network node, the second message comprising the output feedback identifier.

4. The method of claim 3, wherein the second message is a Handover Request or a NG-RAN Node Configuration Update.

5. The method of claim 3, wherein the output comprises an action for at least one of the first network node or the second network node to perform.

6. The method of claim 1, wherein the output feedback identifier is a parametrization of one or more outputs generated by the ML model.

7. The method of claim 1, wherein the output feedback identifier is a value assigned out of a predefined or configured range of values.

8. The method of claim 1, wherein the output feedback identifier further comprises one or more of:
an indication related to the ML model,
an indication related to a use case to which the output of the ML model corresponds to,
an indication related to the output generated at the first node,
an indication related to a second output generated earlier at the first network node or a different network node,
an indication related to a time at which the output was generated,
an indication related to an area in the RAN for which the output was generated,
an indication related to the first network node,
an indication related to one or more network nodes receiving, involved in, or affected by the output, or
a slice in the RAN to which the output corresponds to.

9. The method of claim 1, further comprising: receiving a third message generated by the third network node, wherein the third message comprises a request to collect and provide data associated with the output of the ML model.

10. The method of claim 9, wherein the third message comprises information indicating the output feedback identifier or a configuration to determine the output feedback identifier, and wherein the obtaining the output feedback identifier further comprises:
determining the output feedback identifier based on the information.

11. (canceled)

12. The method of claim 1, wherein the output from the ML model comprises a predicted parameter, metric, or quantity in the RAN.

13. The method of claim 12, further comprising:
obtaining, from a second network node, a first measurement relating to the parameter, metric, or quantity; and
determining a model prediction error of the ML model based on the first measurement.

14. The method of claim 13, further comprising:
obtaining, at the first network node, a second measurement relating to the parameter, metric, or quantity, wherein the determining the model prediction error of the ML model is based on the first measurement, the second measurement, or a combination of the first and second measurement.

15. The method of claim 12, further comprising:
obtaining, from the second network node, a model prediction error of the ML model based on a measurement relating to the parameter, metric, or quantity.

16-27. (canceled)

28. The method of claim 2, further comprising:
training, monitoring, evaluating, or updating the ML model using the data.

29-31. (canceled)

32. The method of claim 1, wherein the ML model is executed at the first network node or a different network node.

33. The method of claim 32, wherein the different network node is the third network node.

34. (canceled)

35. The method of claim 1, wherein the third network node is comprised in an Operations, Administration, and Maintenance (OAM) or a Service, Management, and Orchestration (SMO) system.

36. (canceled)

41. A first network node in a radio access network (RAN) adapted to:
obtain an output from a machine learning (ML) model;
obtain an output feedback identifier for the output, wherein the output feedback identifier uniquely identifies the output;
generate a first message, wherein the first message comprises the output feedback identifier; and
transmit, towards a third network node, the first message comprising the output feedback identifier.

42. A computer program comprising instructions which when executed by processing circuitry of a first network node causes the network node to:
obtain an output from a machine learning (ML) model;
obtain an output feedback identifier for the output, wherein the output feedback identifier uniquely identifies the output;
generate a first message, wherein the first message comprises the output feedback identifier; and
transmit, towards a third network node, the first message comprising the output feedback identifier.

43. (canceled)
